(19) United States
(12) Patent Application Publication
(10) Pub. No.: US 2015/0067536 A1
(43) Pub. Date: Mar. 5, 2015

(54) Gesture-based Content Sharing Between Devices

(71) Applicant: Microsoft Corporation, Redmond, WA (US)

(72) Inventors: Simone Leorin, Redmond, WA (US); Anton W. Krantz, Kirkland, WA (US); William George Verthein, Sammamish, WA (US); Devi Brunsch, Sammamish, WA (US); Nghiep Duy Duong, Sammamish, WA (US); Steven Wei Shaw, Bellevue, WA (US)

(21) Appl. No.: 14/015,908

(22) Filed: Aug. 30, 2013

(51) Int. Cl. H04L 29/06

(52) U.S. Cl. CPC H04L 65/403
USPC 715/753

(57) ABSTRACT

Various embodiments provide an ability to join a virtual conference session using a single input-gesture and/or action. Upon joining the virtual conference, some embodiments enable a computing device to share content within the virtual conference session responsive to receiving a single input-gesture and/or action. Alternately or additionally, the computing device can acquire content being shared within the virtual conference session responsive to receiving a single input-gesture and/or action. In some cases, content can be exchanged between multiple computing devices connected to the virtual conference session.

### BACKGROUND

A conference room environment typically allows multiple people to simultaneously share content with one another. For example, a computer can be connected to a video projection system, thus enabling the people to view content controlled and/or projected by the computer with greater ease. In some cases, the video projection system can be connected to a virtual conference session containing multiple participants However, the connection process between the computer, video projection system, and/or virtual conference session can be complicated and involve multiple steps by a user to establish the connectivity. In turn, this can delay the start of a meeting while the user works through these various steps.

### SUMMARY

This Summary is provided to introduce a selection of concepts in a simplified form that are further described below in the Detailed Description. This Summary is not intended to identify key features or essential features of the claimed subject matter.

Various embodiments provide an ability to join a virtual conference session using a gesture-based input and/or action. Upon joining the virtual conference, some embodiments enable a computing device to share content within the virtual conference session responsive to receiving a gesture-based input and/or action. Alternately or additionally, the computing device can acquire content being shared within the virtual conference session responsive to receiving a gesture-based input and/or action. In some cases, content can be exchanged between multiple computing devices connected to the virtual conference session.

### BRIEF DESCRIPTION OF THE DRAWINGS

The detailed description references the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment with an example implementation that is operable to perform the various embodiments described herein.

FIG. 2 is an illustration of an environment in an example implementation in accordance with one or more embodiments.

FIG. 3 is a flow diagram in accordance with one or more embodiments.

FIGS. 4a and b are illustrations of an environment with example implementations in accordance with one or more embodiments.

FIG. 5 is a flow diagram in accordance with one or more embodiments.

FIG. 6 is an example computing device that can be utilized to implement various embodiments described herein.

### DETAILED DESCRIPTION

### Overview

Various embodiments provide an ability to join a virtual conference session using a gesture-based input and/or action. In some instances, the gesture-based input can comprise a single input. A first computing device can automatically connect and/or pair with a second computing device. The first computing device includes functionality and/or privileges to moderate and/or join the virtual conference session. The second computing device includes at least some virtual conference functionality that responds and/or executes commands that are received from the first computing device. When the first computing device has connected to the second computing device, a user can perform a gesture-based input, e.g., a single input, relative to the first computing device to join the virtual conference session. Once the virtual conference session has been joined, content from the first computing device can be shared into the virtual conference session by the user performing a gesture-based input associated with a sharing action. The gesture-based input can comprise any suitable type of input such as, by way of example and not limitation, a single input. After content has been shared into the virtual conference session, some embodiments enable other computing devices and/or participants to view and/or access the shared content. In some cases, the first computing device can acquire content shared by other computing devices and/or participants in the virtual conference session using a gesture-based input associated with an acquisition action. This can also include multiple computing devices within a virtual conference center sharing and/or transferring content between one another.

In the following discussion, an example environment is first described that may employ the techniques described herein. Example procedures are then described which may be performed in the example environment, as well as other environments. Consequently, performance of the example procedures is not limited to the example environment and the example environment is not limited to performance of the example procedures.

Example Environment

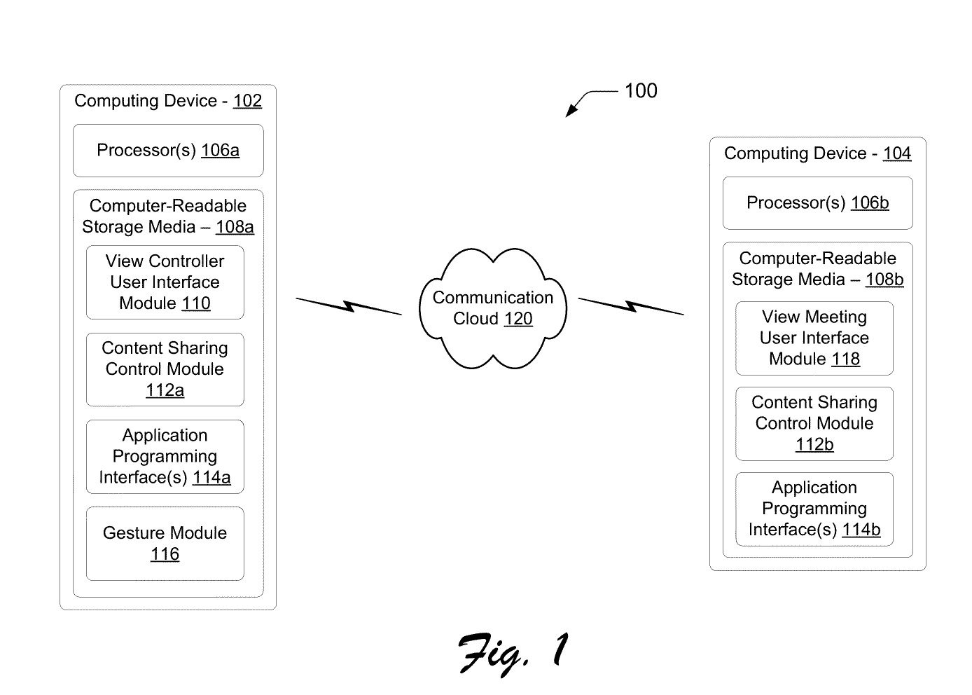

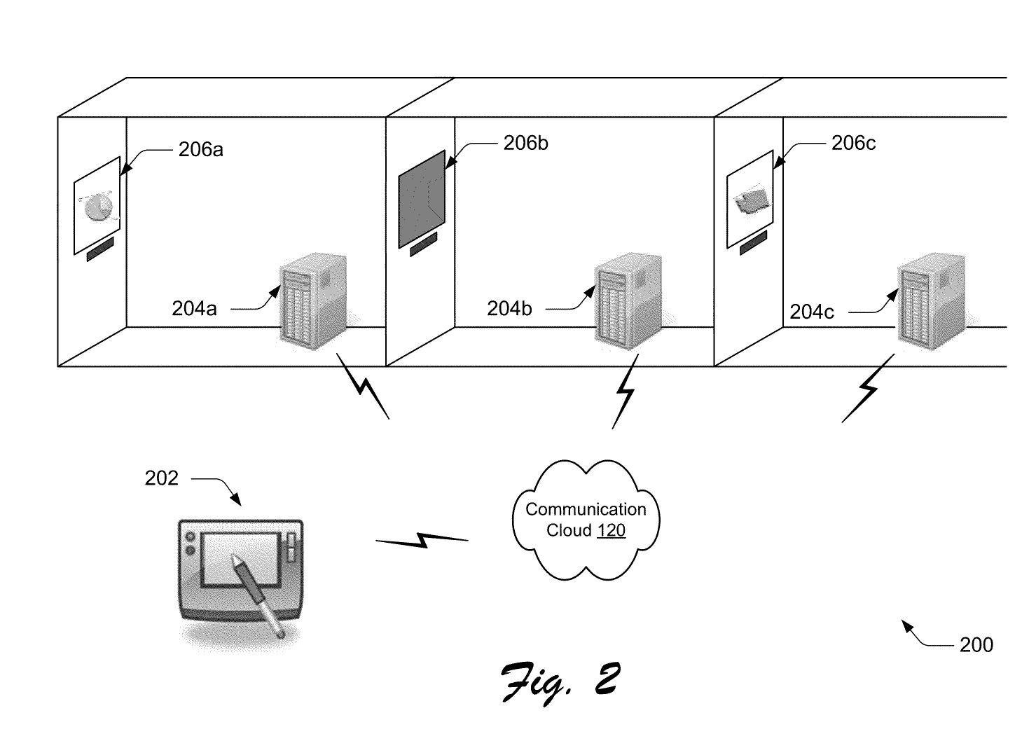

FIG. 1 illustrates an operating environment 100 in accordance with one or more embodiments. Environment 100 includes a computing device 102 and a computing device 104, which each represent any suitable type of computing device, such as a tablet, a mobile telephone, a laptop, a desktop Personal Computer (PC), a server, a kiosk, an audio/video presentation computing device, an interactive whiteboard, and so forth. In some embodiments, computing device 102 represents a computing device configured to join and/or share content in a virtual conference session based upon a gesture-based input, e.g., a single input-gesture. Computing device 104 represents a computing device that can receive commands and/or content from computing device 102 (as well as other similar computing devices), and share content with other participants in the virtual conference session. In some cases, computing device 102 can control and/or modify content associated with the virtual conference session by sending commands to computing device 104. While computing devices 102 and 104 are each illustrated as a single device, it is to be appreciated and understood that functionality described with reference to computing devices 102 and 104 can be implemented using multiple devices without departing from the scope of the claimed subject matter.

In FIG. 1, computing devices 102 and 104 are illustrated as including similar modules and/or components. For simplicity's sake, these similar modules will be annotated using a naming convention of “1XXa” and “1XXb”, where designators appended with “a” refer to modules and/or components included in computing device 102, and designators appended with “b” refer to modules and/or components included in computing device 104.

Computing devices 102 and 104 include processor(s) 106a and 106b, in addition to computer-readable storage media 108a and 108b. Here, computing device 102 is illustrated as including view controller user interface (UI) module 110, content sharing control module 112a, Application Programming Interface(s) (API) 114a, and gesture module 116, that reside on computer-readable storage media 108a and are executable by processors 106a. Similarly, computing device 104 is illustrated as including content sharing control module 112b, Application Programming Interface(s) (API) 114b, and view meeting user interface (UI) module 118, that reside on computer-readable storage media 108b, and are executable by processors 106b. The computer-readable storage media can include, by way of example and not limitation, all forms of volatile and non-volatile memory and/or storage media that are typically associated with a computing device. Such media can include ROM, RAM, flash memory, hard disk, removable media and the like. Alternately or additionally, the functionality provided by the processor(s) 106a and 106b, and modules 110, 112a and 112b, 114 a and 114b, 116, and/or 118 can be implemented in other manners such as, by way of example and not limitation, programmable logic and the like.

View controller user interface module 110 represents functionality that manages a UI of computing device 102 and/or what is viewed on the UI. This can include managing data generated from multiple applications, video streams, and so forth. View controller user interface module 110 can also manage and/or enable changes to how content is presented and/or consumed by one or more computing devices associated with a virtual conference session. In some cases, this can include managing options associated with how participants can interact with the content (e.g. presentation privileges, audio settings, video settings, and so forth). At times, view controller user interface module 110 can identify updates on the UI from these various sources, and forward these updates for consumption in the virtual conference session. Alternately or additionally, view controller user interface module 110 can update the UI of computing device 102 based upon commands and/or visual updates received from computing device 104. Thus, view controller user interface module 110 manages a view state associated with computing device 102, where the view state can depend upon the virtual conference session and/or associated displayed content.

Content sharing control modules 112a and 112b represent functionality configured to send and receive content and/or control messages between computing device 102 and computing device 104. In some embodiments, the control messages are associated with sharing and receiving content in the virtual conference session, such as audio and/or video content, as further described below. At times, content sharing control modules 112a and 112b share content and/or control messages with view controller user interface module 110 and view meeting user interface module 118, respectively. The content can be any suitable time of content, such as images, audio, files, and so forth. Further, the control messages can be any suitable type of command, query, or request, such as commands related to behavior associated with a virtual conference session (e.g. allow participants, remove participants, mute/unmute participants, invite participants, update display, and so forth).

Application Programming Interface(s) (APIs) 114a and 114b represent programmatic access to one or more applications. In some cases, applications can be configured to coordinate and/or provide additional functionality to (and/or functionality optimized for) the virtual conference session. For example, APIs 114a can be used to relay events generated through view controller user interface module 110 to other applications and/or computing devices. A user event identified by view controller user interface module 110 (such as a click, swipe, tab, etc) can be passed down to API(s) which, in turn, can be configured to relay and/or forward the event via Transmission Control Protocol/Internet Protocol (TCP/IP) to another computing device associated with the virtual conference session. These events can include commands, as further described below. Similarly, API(s) 114a and/or 114b can receive messages, commands, and/or events over TCP/IP from external computing devices which, in turn, are forwarded to view controller user interface module 110. Thus, API(s) 114a and 114b can be configured to provide computing device 102 and/or computing device 104 with access to additional functionality associated with a virtual conference session.

Gesture module 116 represents functionality that recognizes input gestures, and causes and/or invokes operations to be performed that correspond to the gestures. The gestures may be recognized by gesture module 116 in a variety of different ways. For example, gesture module 16 may be configured to recognize a touch input, a stylus input, a mouse input, a natural user interface (NUI), and so forth. Gesture module 116 can be utilized to recognize single-finger gestures and bezel gestures, multiple-finger/same-hand gestures and bezel gestures, and/or multiple-finger/different-hand gestures and bezel gestures. In some embodiments, a single input-gesture can entail multiple inputs that are interpreted as a single input (e.g. a double-tap gesture, a touch-and-slide gesture, and so forth). At times, gesture module 116 can interpret an input gesture based upon a state associated with computing device 102 (such as an input gesture can invoke a different response based upon whether computing device 102 is joined in a virtual conference session, is not joined in a virtual conference session, has control of the virtual conference session, what application currently has priority, and so forth). Thus, gesture module 116 represents an ability to detect and interpret input gestures, whether the input is a single gesture or a combination of multiple gestures.

When View meeting user interface module 118 represents functionality that manages a UI of computing device 104 and/or what is viewed on the UI. In some cases, view meeting user interface module 118 manages the UI of computing device 104 relative to the virtual conference session. For example, view meeting user interface module 118 can receive commands originating from computing device 102, and update the UI of computing device 104 accordingly. At times, view meeting user interface module 118 can interface and/or interact with API(s) 114b in a manner similar to that described above. In some embodiments, view meeting user interface module 118 can receive commands from another computing device (not illustrated here) that is a participant in the virtual conference session, update the UI of computing device 104, and/or forward the command to computing device 102. Thus, view meeting user interface module 118 manages the state of the UI associated with computing device 104 based on inputs from one or more participants in the virtual conference session.

Environment 100 also includes communication cloud 120. Communication cloud 120 generally represents a bi-directional link between computing device 102 and computing device 104. Any suitable type of communication link can be utilized. In some embodiments, communication cloud 120 represents a wireless communication link, such as a Bluetooth wireless link, a wireless local area network (WLAN) with Ethernet access and/or WiFi, a wireless telecommunication network, and so forth.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

Having described an example environment in which the techniques described herein may operate, consider now a discussion of joining a virtual conference session using a single input-gesture that is in accordance with one or more embodiments. It is to be appreciated and understood that the functionality described below can be accessed using gestures other than the single input gesture.

Automatically Joining a Conference Using a Single Input-Gesture

Virtual conferences are a way for multiple computing devices to connect with one another for a shared presentation and/or exchange of information. For example, computing devices running associated virtual conference client applications can connect with one another to exchange content between computing devices in a virtual conference session. Among other things, the participants of the virtual conference session can more freely share content with one another in a protected environment by excluding non-participants of the virtual conference session (e.g. computing devices that have not joined the virtual conference session) from having access to the shared content. In some cases, the virtual conference session can be configured to only allow certain participants to join, such as participants with an appropriate access code, participants with an invitation, participants with appropriate login credentials, and so forth. While the virtual conference session can be a powerful tool in which computing devices can exchange content, the added security of monitoring which participants can join the virtual conference session sometimes makes it difficult for a participant to join, and sometimes adds extra (and complicated) steps.

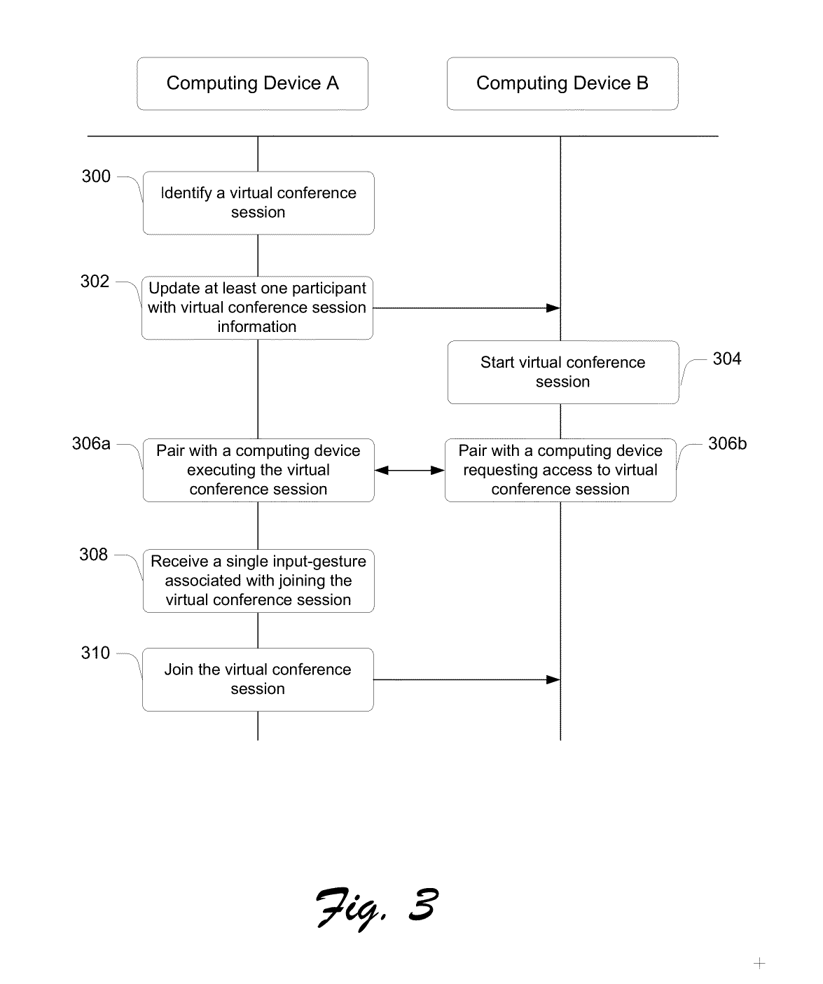

Various embodiments provide an ability to join a virtual conference session using a single input-gesture and/or action. In some cases, a computing device can be figured to automatically pair and/or connect selectively with a second computing device, and subsequently join a virtual conference session running on the second computing device responsive to receiving the single input-gesture. Consider FIG. 2, which illustrates an example environment 200 in accordance with one or more embodiments.

Environment 200 includes computing device 202 and computing devices 204a-c. In some embodiments, computing device 202 can be computing device 102 of FIG. 1, while computing devices 204a-c can be one or more versions of computing device 104 of FIG. 1. Here, computing device 202 is illustrated as a handheld tablet with an associated stylus. However, it is to be appreciated and understood that computing device 202 can be any suitable type of computing device that receives input in any suitable manner, examples of which are provided above. Similarly, while computing devices 204a-c are visually illustrated in FIG. 2 as being of a same type with one another, this is merely for simplification purposes. As in the case of computing device 202, computing devices 204a-c can be any suitable type of computing device and/or can vary from one another without departing from the scope of the claimed subject matter. In this example, computing device 204a-c are operatively coupled to presentation devices 206a-c, respectively (e.g. computing device 204a being operatively coupled to presentation device 206a, computing device 204b being operatively coupled to presentation devices 206b, and so forth).

Among other things, presentation devices 206a-c can visually and/or audibly share content with multiple users, such as people located in a meeting room. The presentation devices can be any suitable type and/or combination of devices, such as a projection system and/or an audio system. In some embodiments, a presentation device can include an interactive (electronic) whiteboard, where a user can interact with what is displayed on the whiteboard using gesture input(s). Here, the gesture input(s) are detected and/or processed by a computing device associated with the interactive whiteboard. At times, the interactive (electronic) whiteboard can modify and/or rearrange what is displayed based upon the gesture input(s). In this example, computing devices 204a-c are operatively coupled to presentation devices 206a-c, respectively, and can actuate and/or control what content is shared (e.g. displayed and/or played) through the presentation devices. For example, computing device 204a is illustrated as projecting a pie chart using a video projection system associated with presentation device 206a. While illustrated here as separate components, it is to be appreciated that some embodiments can integrate computing devices 204a-c and their associated presentation device counterpart into a single device. Alternately or additionally, presentation devices 206a-c can be accessories and/or auxiliary devices of computing devices 204a-c.

Here, computing device 202 is configured to enable a user to easily transport computing device 202 to different locations while retaining and/or establishing connectivity with a network. In some cases, connectivity can be established and/or retained without disconnecting and/or connecting cables to computing device 202. For instance, computing device 202 can automatically disconnect and reconnect to one or more networks as it moves in and out of range of the various networks. When moving into a working proximity of a network (e.g. a proximity in which communications using the network are successful), some embodiments of computing device 202 can automatically detect virtual conference session(s), and further attempt to pair and/or connect with the computing device running the virtual conference session, the virtual conference session itself, and/or associated client software. For example, computing devices 204a-c are illustrated in FIG. 2 as residing in separate meeting rooms and executing separate virtual conference sessions from one another. In some cases, computing devices 204a-c can be connected to one or more networks, represented here generally as communication cloud 120 of FIG. 1. In some embodiments, as computing device 202 moves in range and/or proximity between computing devices 204a-c (such as a user carrying the tablet down a hallway up between conference rooms), it can detect which virtual conference session(s) are in progress, and additional identify a virtual conference session to join.

At times, identifying virtual conference session(s) in progress can be based upon one or more parameters associated with the virtual conference session(s), such as a passcode and/or predetermined identifier, a Service Set Identifier (SSID), and so forth. In this manner, computing device 202 can determine which virtual conference session(s) can be joined, and which cannot. In some cases, computing device 202 can pair with computing device 204a, 204b, and/or 204c using a connection that is dependent upon proximity, such as a local Bluetooth connection. Alternately or additionally, computing device 202 can pair and/or connect with computing device 204a, 204b, and/or 204c using a WLAN connection. However, success of the pairing and/or connection oftentimes depends upon whether the computing device attempting to pair has an appropriate identifier and/or appropriate credentials. For example, an organizer of a virtual conference session can configure a virtual conference session with a particular SSID value. In turn, an associated kiosk (such as computing device 204a, 204b, and/or 204c) can be configured to operatively transmit the SSID an over a network at a predetermined meeting time, such as a window set at, or around, the meeting start time set by the organizer. When a computing device with a corresponding SSID and/or pairing code moves into working range of the network within a window around predefined time, it can automatically pair with the kiosk based, at least in part, on having the appropriate SSID value and/or corresponding code pair to the SSID value.

To further illustrate, consider a case where computing device 202 is associated with organizing a virtual conference session at 2:00 PM running on computing device 204c. At 2:00 PM (or at a predetermined amount of time prior to the selected conference time), computing device 204c transmits the associated SSID. At the same time, a second (and unrelated virtual conference session) is in progress using a computing device 204a. As computing device 202 moves past the conference room containing computing device 204a, it fails any attempted pairing with computing device 204a since it does not have the appropriate knowledge (e.g. SSID and/or pairing code). Proceeding on, when computing device 202 moves into working proximity of computing device 204c, the two are able to successfully pair with one another since the computing device 202 has the corresponding SSID and/or pairing code. Thus, computing device 202 can be automatically authenticated as a valid participant of the virtual conference session based, at least in part, upon the successful pairing. Upon establishing a successful pairing and/or connection between computing device 202 and computing device 204c, a user can then join the virtual conference session using a single input-gesture.

As discussed above, the successful pairing and/or connection between computing devices can be used as a way to authenticate one or more participants of a virtual conference session. In some cases, once a pairing has been established, a visual notification of the pairing can be displayed to a user, such as a pop-up box, an icon, a message banner, and so forth. At this point, the user can join the virtual conference session using a single input-gesture. Any suitable type of single input-gesture can be used. For example, in some cases, the user can tap the visual notification with a finger on a touch screen, touchpad, using a stylus, and so forth. Alternately or additionally, the single input-gesture can be a combination of inputs, such as a touch-and-slide of a finger on the touch screen, a double-tap, and so forth. In some cases, when a participant has successfully joined a virtual conference session (via a computing device), one or more applications associated with the virtual conference session can be launched and/or given priority for execution, such as presentation software. Upon joining the virtual conference session, a user of the joined computing device can share content and/or acquire content in the virtual conference session as further described below.

FIG. 3 is a flow diagram that describes steps in one or more methods in accordance with one or more embodiments. The method can be performed by any suitable hardware, software, firmware, or combination thereof. In at least some embodiments, aspects of the method can be implemented by one or more suitably configured software modules executing on one or more computing device, such as content sharing modules 112a and/or 112b of FIG. 1. In the discussion that follows, the method is broken out in the flow diagram in two different columns. These columns are utilized to represent the various entities that can perform the described functionality. Accordingly, the column labeled “Computing Device A” includes acts that are performed by a suitably-configured computing device, such as those performed by computing device 102 and/or computing device 202 of FIGS. 1 and 2 respectively. Likewise, the column labeled “Computing Device B” includes acts that are performed by a suitably-configured kiosk-type computing device, such as those performed by computing device 104 and/or computing devices 204a-c of FIGS. 1 and 2 respectively.

Step 300 identifies a virtual conference session. Identifying can include creating a new virtual conference session, as well as receiving an invite and/or information associated with the virtual conference session. For instance, in some embodiments, computing device A can used by a moderator to create a new virtual conference session, set the virtual conference start time, invite participants to the virtual conference session, and so forth. Alternately or additionally, computing device A can be used by a participant of the virtual conference session that receives the invite and/or information related to the virtual conference session, such as a login information and/or login passcodes from the moderator. In some cases, computing device A can be a mobile computing device that the moderator transfers virtual conference session information to, and so forth. Thus, identifying a virtual conference session can include creating the virtual conference session and/or receiving information related to the virtual conference session (e.g. a participant receiving an invite to the virtual conference session, a moderator transferring virtual session information and/or shareable content to a mobile computing device, and so forth).

Step 302 updates at least one participant with virtual conference session information. For example, in the case where computing device A is a computing device used by the moderator to create the virtual conference session, some embodiments update participants with information, inform participants of, and/or invite potential participants to the new virtual conference session. In some cases, updates can be sent to computing device B. Alternately or additionally, some embodiments forward authentication credentials, passcodes, and/or login information to participants.

Step 304 starts a virtual conference session, such as a virtual conference session created in step 300. Here, the virtual conference session is started on computing device B and can be based, at least in part, on information forwarded from computing device A. Starting the virtual conference session can occur at any suitable time. In some cases, the virtual conference session is started at a predetermined meeting time. In other cases, the virtual conference session is started prior to the predetermined meeting time, such as 10 minutes before the predetermined meeting time, in order to allow participants and/or associated computing devices time to pair, connect, and/or join to the virtual conference session, as further described above and below. As part of the starting process, some embodiments transmit information over a network that can be used to pair and/or connect to the virtual conference session. Alternately or additionally, starting the virtual conference session can include starting a shell and/or empty framework of a virtual conference session. Here, starting an empty framework and/or shell of a virtual conference session represents starting functionality that enables users to join the virtual conference session, but is void of at least some content from participants, such as a presentation file, associated audio, video, images, and/or slides. For instance, an empty framework of a virtual conference session might contain a standard startup image that is displayed and/or standard audio (that is played for all virtual conference sessions) until the moderator joins.

Step 306a pairs with a computing device executing the virtual conference session. In some embodiments, the pairing and/or connecting can be performed automatically and without user intervention at the time of the pairing. In this example, computing device A pairs and/or connects with computing device B, where computing device B is executing the virtual conference session, as further described above. Similarly, step 306b pairs with a computing device (illustrated here as computing device A) requesting access to the virtual conference session. Oftentimes, these steps utilize multiple iterations of hand-shakings and/or messages between one another to establish a successful pairing and/or connection, generally represented here through the naming convention of “306a” and “306b”. In some cases, step 306b can be a one-to-many action, where computing device B can be configured to pair and/or connect with multiple computing devices for a same virtual conference session.

Step 308 receives a single input-gesture associated with joining the virtual conference session. Any suitable type of single input-gesture can be received, examples of which are provided above.

Responsive to receiving the single input-gesture, step 310 joins the virtual conference session. At times, this can occur automatically and/or without additional user input (aside from the single input-gesture). In some embodiments, joining the virtual conference session can entail one or more command messages being exchanged between the participating computing devices.

Having described how a user can automatically join a virtual conference session using a single input-gesture, consider now a discussion of exchanging content in a virtual conference session in accordance with one or more embodiments.

Exchanging Content Using a Single Input-Gesture

As discussed above, a virtual conference session enables participants of the virtual conference session to exchange data within the secure confines of the virtual conference session. When a virtual conference session is configured to selectively admit participants, non-participants are typically excluded from the content shared within the boundaries of the virtual conference session. Conversely, upon joining a virtual conference session, a participant typically can share content into the session, as well as acquire content that has been shared. Some embodiments enable the participant to share and/or acquire content associated with the session using a single input-gesture.

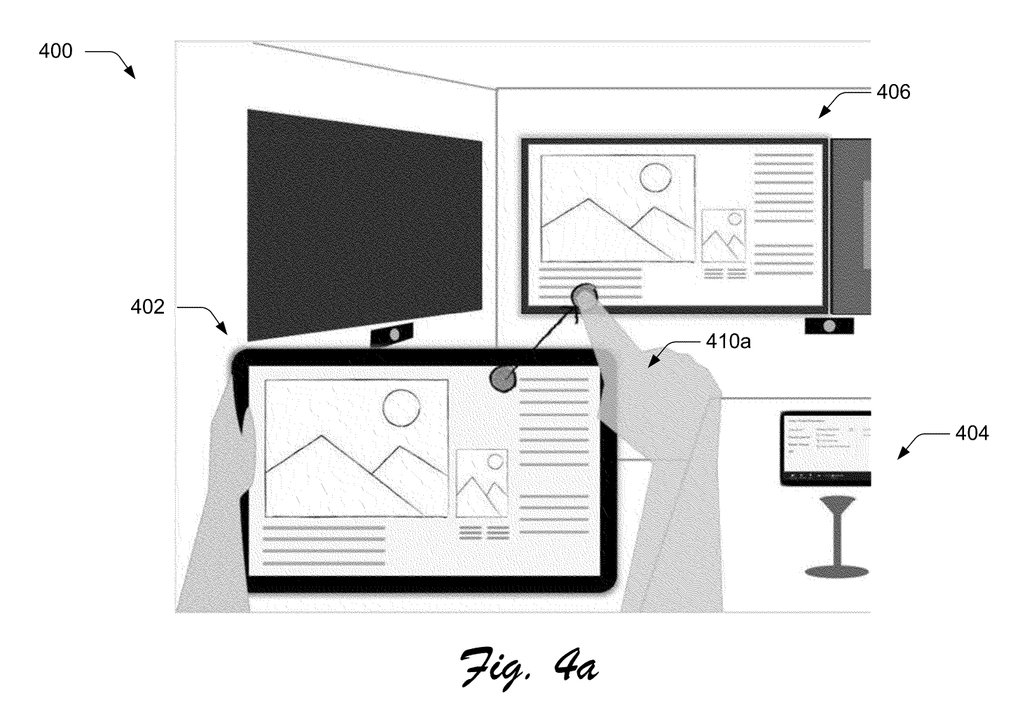

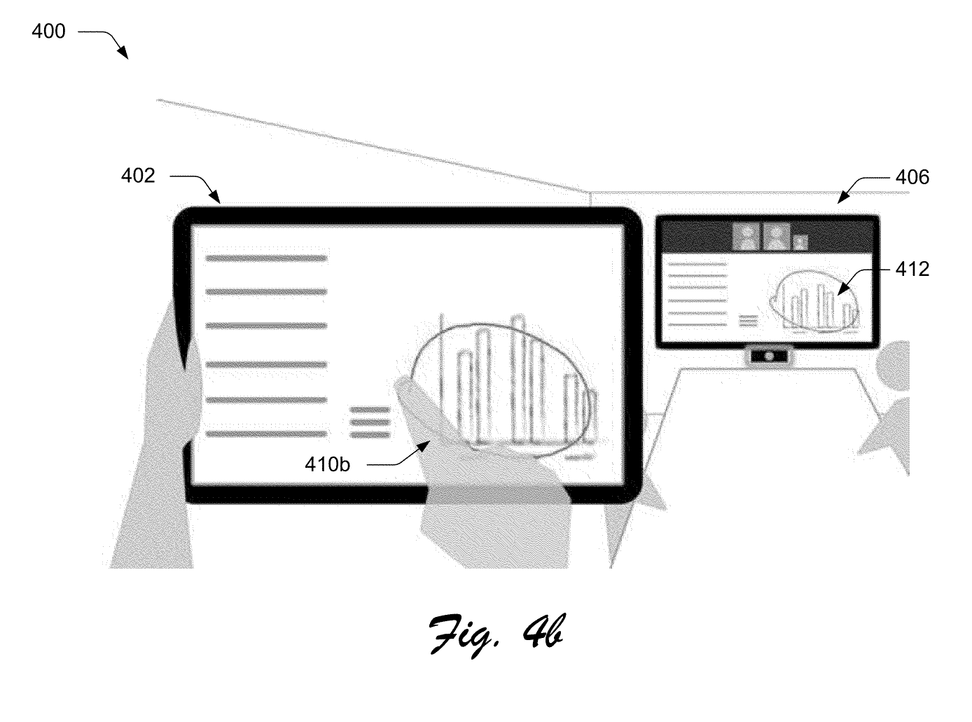

Consider FIGS. 4a and b, which illustrate an example environment 400 in accordance with one or more embodiments. Environment 400 includes a computing device 402, computing device 404, and/or presentation device 406. In some embodiments, computing device 402 is representative of computing device 102 of FIG. 1 and/or computing device 202 of FIG. 2, computing device 404 is representative of computing device 104 of FIG. 1 and/or one of computing devices 204a-c of FIG. 2, and presentation device 406 is representative of one of presentation devices 206a-c of FIG. 2. Here, computing device 402 is illustrated as a tablet with a touch screen interface.

In this example, computing device 402 has joined a virtual conference session that is running on computing device 404, similar to that described above. In some embodiments, computing device 402 is configured to be a moderator of the virtual conference session, while computing device 404 is configured to run application and/or client software associated with the virtual conference session. During the virtual conference the session, a user of computing device 402 decides to share content within the context of the virtual conference session. Some embodiments enable the user to enter a single input-gesture to initiate the sharing process. Here, the user enters input-gesture 410a by performing a touch-and-slide gesture on the touch screen of computing device 402, where the slide portion of the input-gesture radiates outwards from computing device 402 and/or towards the general direction of presentation device 406. However, it is to be appreciated and understood that any suitable type of input gesture can be utilized without departing from the scope of the claimed subject matter.

Upon detecting and/or identifying the single input-gesture, computing device 402 determines which content to share within the context of the virtual conference session. In some cases, it determines to share content associated with what is currently displayed on the screen of computing device 402. This can include all of the displayed content, or a portion of the displayed content based upon identifying the single input-gesture. For instance, a first type of input-gesture can be associated with sharing all displayed content, while a second type of input-gesture can be associated with sharing a portion of the displayed content, and so forth. Alternately or additionally, computing device 402 can determine to share content associated with one or more application, such as by associating an input-gesture with sharing content currently playing on an audio application, by associating an input-gesture with sharing content currently loaded in a spreadsheet application, and so forth. While discussed in the context of sharing content from computing device 402 into an associated virtual conference session, single input-gestures can also be used to acquire content being shared in the virtual conference session. For example, a user of computing device 402 can use a touch-and-slide gesture that radiates from an outer edge of computing device 402 towards a general inward direction to receive content from the virtual conference session running on computing device 404 to computing device 402. Thus, single input-gestures can be used to share and acquire content in the context of a virtual conference session. In at least some embodiments, content sharing can be bi-directional and/or multi-directional (as between individual participants in the session. Alternately or additionally, input-gestures can be used and/or interpreted as annotation or navigation actions, such as a left-to-right gesture being associated with switching displayed images and/or documents in the virtual conference session, a tap-and-hold being associated with displaying pointer on an object and/or portion of a display, and so forth.

As another example, consider FIG. 4b. Here, the user annotates and/or augments the content being displayed on a computing device 402 and presentation device 406. Input-gesture 410b is input by a user to annotate and/emphasize a portion of the display by circling and/or highlighting and an area of interest. In turn, a presentation display 406 is updated with annotation 412 that reflects and/or tracks the display updates on computing device 402. In some embodiments, the input-gestures can be interpreted based on which applications are running and/or whose output is foremost on the display. For example, when the user performs input-gesture 410b on a display associated with a presentation application, computing device 402 can be configured to send one or more commands associated with annotating the virtual conference session display. However, if the user performs input-gesture 410b on a display associated with a web browser application, computing device 402 may be configured to ignore this input. Thus, in some embodiments, computing device 402 can be configured to selectively interpret an input-gesture based upon which application is running and/or is the foremost application running on a display.

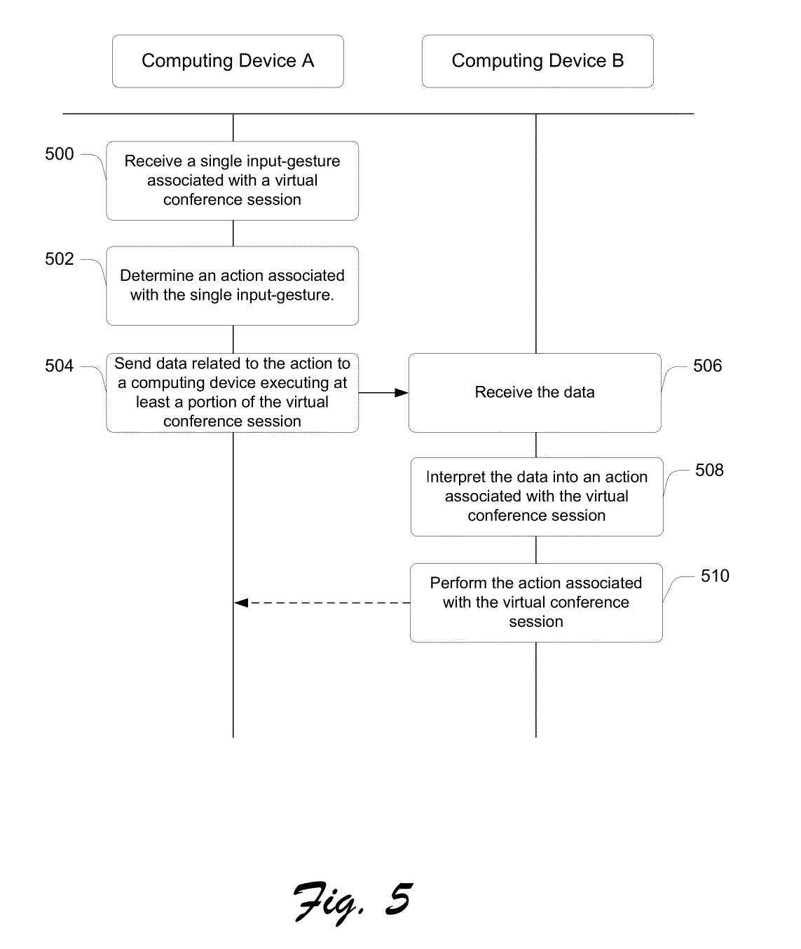

To further illustrate, consider FIG. 5, which contains a flow diagram that describes steps in a method in accordance with one or more embodiments. The method can be implemented in connection with any suitable hardware, software, firmware, or combination thereof. In at least some embodiments, the method can be implemented by a suitably-configured system such as one that includes, among other components, content sharing module 112a and/or 112b as discussed above with reference to FIG. 1. In the discussion that follows, the method is broken out in the flow diagram in two different columns. These columns are utilized to represent the various entities that can perform the described functionality. Accordingly, the column labeled “Computing Device A” include acts that are performed by a suitably-configured computing device, such as those performed by computing device 102 and/or computing device 202 of FIGS. 1 and 2 respectively. Likewise, the columns labeled “Computing Device B” include acts that are performed by a suitably-configured kiosk-type computing device, such as those performed by computing device 104 and/or computing devices 204a-c of FIGS. 1 and 2 respectively.

Step 500 receives a single input-gesture associated with a virtual conference session. In some cases, the virtual conference session has already been established and/or is running, and the computing device receiving the single input-gesture has successfully joined the virtual conference session. Any suitable type of input-gesture can be received, such as a touch-and-slide, a double-tap, a single tap, a tap-and-hold, a pinch, a wave and/or grab gesture, and so forth. Further, any suitable type of input device can be used to capture and/or receive the single-input gesture, examples of which are provided above. The single input-gesture can include one or more combinations of inputs that, on a whole, can be interpreted as a single input-gesture.

Step 502 determines an action associated with the single input-gesture. In some cases, the determination can be based upon the type of content being displayed on associated computing device. Alternately or additionally, the determination can be based upon which applications are currently running on the computing device and/or which application is foremost on the display. Thus, in some cases, a single input-gesture can be interpreted based upon one or more parameters. Further, a single input-gesture can be associated with any suitable type of action, such as an action associated with sharing content, acquiring content, annotating content, changing the displayed content, and so forth.

Step 504 sends data related to the action to a computing device executing at least a portion of the virtual conference session. In some cases, the data is sent automatically and without additional user intervention (aside from the single input-gesture). For example, in some embodiments, the data can include at least part of the content to be shared in the virtual conference session. Alternately or additionally, the data can include one or more commands to direct behavior of the computing device receiving the data (e.g. computing device B), such as a “share content” command, an “acquire content” command, an “update display” command, an “add participant” command, a “terminate virtual conference session” command, so forth. In some embodiments, the sending computing device and the receiving computing device are each configured to run client and/or application software associated with the virtual conference session to facilitate sending and receiving commands between one another.

Step 506 receives the data. As discussed above, the received data can include content to share and/or display in a virtual conference session, as well as one or more commands related to the behavior of the virtual conference session. Responsive to receiving the data, step 508 interprets the data into an action associated with the virtual conference session, examples of which are provided above.

Step 510 performs the action associated with the virtual conference session. Any suitable type of action can be performed, such as updating a display with content, playing audio, forwarding content to one or more participants in the virtual conference session, and so forth. In some cases, the action can include returning and/or sending content back to a requesting computing device, indicated here by a dashed line returning to computing device A. Alternately or additionally, performing the action can include multiple steps, iterations, handshakes, and/or responses.

Thus, some embodiments provide a user with an ability to initiate actions associated with a virtual conference session utilizing a single-input gesture. Having considered a discussion of single input-gestures related to a virtual conference session, consider now an example system and/or device that can be utilized to implement the embodiments described above.

Example System and Device

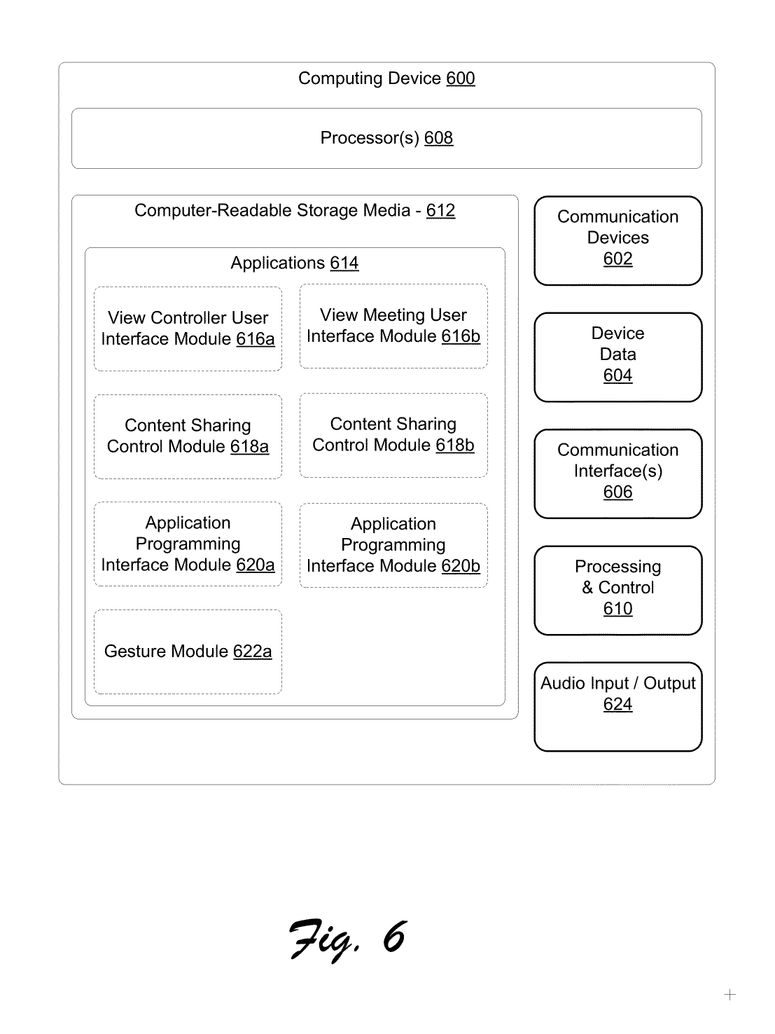

FIG. 6 illustrates various components of an example device 600 that can be implemented as any type of computing device as described with reference to FIGS. 1-5 to implement embodiments of the techniques described herein. In some cases, device 600 represents an example implementation of computing device 102 of FIG. 1, while in other cases, device 600 represents an example implementation of computing device 104 of FIG. 1. For simplicity's sake, FIG. 6 includes modules for both types of implementations, which will be discussed together. To distinguish between the implementations, modules using a “6XXa” naming convention (e.g. “a” appended at the end) relate to a first implementation, while a “6XXb” naming convention (e.g. “b” appended at the end) relate to a second implementation. In addition to this name convention, these modules are illustrated using border with a dashed line. However, it is to be appreciated that any implementation can include varying combinations of modules without departing from the scope of the claimed subject matter.

Device 600 includes communication devices 602 that enable wired and/or wireless communication of device data 604 (e.g. received data, data that is being received, data scheduled for broadcast, data packets of the data, etc.). The device data 604 or other device content can include configuration settings of the device and/or information associated with a user of the device.

Device 600 also includes communication interfaces 606 that can be implemented as any one or more of a serial and/or parallel interface, a wireless interface, any type of network interface, a modem, and as any other type of communication interface. In some embodiments, communication interfaces 606 provide a connection and/or communication links between device 600 and a communication network by which other electronic, computing, and communication devices communicate data with device 600. Alternately or additionally, communication interfaces 606 provide a wired connection by which information can be exchanged.

Device 600 includes one or more processors 608 (e.g., any of microprocessors, controllers, and the like) which process various computer-executable instructions to control the operation of device 600 and to implement embodiments of the techniques described herein. Alternatively or in addition, device 600 can be implemented with any one or combination of hardware, firmware, or fixed logic circuitry that is implemented in connection with processing and control circuits which are generally identified at 610. Although not shown, device 600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 600 also includes computer-readable media 612, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like.

Computer-readable media 612 provides data storage mechanisms to store the device data 604, as well as various applications 614 and any other types of information and/or data related to operational aspects of device 600. The applications 614 can include a device manager (e.g., a control application, software application, signal processing and control module, code that is native to a particular device, a hardware abstraction layer for a particular device, etc.). The applications 614 can also include any system components or modules to implement embodiments of the techniques described herein. In this example, applications 614 include view controller user interface module 616a, view meeting user interface module 616b, content sharing control modules 618a and 618b, application programming interface modules 620a and 620b, and gesture module 622a. While illustrated as application modules, it is to be appreciated that these modules can be implemented as hardware, software, firmware, or any combination thereof.

View controller user interface module 616a is representative of functionality that can control a user interface associated with a virtual conference session, such as a user interface associated with a moderator of the virtual user interface. View meeting user interface module 616b is representative of functionality associated with updating and/or synchronizing a meeting display associated with the virtual conference session, such as a display associated with a kiosk.

Content sharing control modules 618a and 618b are representative of functionality associated with to sending and receiving content and/or control messages between computing devices joined to the virtual conference session, such as a moderator computing device, a participant computing device, and/or a kiosk computing device.

Application programming interface modules 620a and 620b are representative of functionality associated with enabling access to applications utilized by a virtual conference session and/or content sharing control modules 618a and 618b.

Gesture module 622a is representative of functionality configured to identify single input-gestures received from one or more input mechanisms, such as the touch-and-slide input-gesture described above. In some embodiments, gesture module 622a can be further configured to determine one or more actions associated with the single input-gesture.

Device 600 also includes an audio input-output system 624 that provides audio data. Among other things, audio-input-output system 624 can include any devices that process, display, and/or otherwise render audio. In some cases audio system 624 can include one or more microphones to generate audio from input acoustic waves, as well as one or more speakers, as further discussed above. In some embodiments, the audio system 624 is implemented as external components to device 600. Alternatively, the audio system 624 is implemented as integrated components of example device 600.

### CONCLUSION

Various embodiments provide an ability to join a virtual conference session using a single input-gesture and/or action. Upon joining the virtual conference, some embodiments enable a computing device to share content within the virtual conference session responsive to receiving a single input-gesture and/or action. Alternately or additionally, the computing device can acquire content being shared within the virtual conference session responsive to receiving a single input-gesture and/or action. In some cases, content can be exchanged between multiple computing devices connected to the virtual conference session.

Although the embodiments have been described in language specific to structural features and/or methodological acts, it is to be understood that the various embodiments defined in the appended claims are not necessarily limited to the specific features or acts described. Rather, the specific features and acts are disclosed as example forms of implementing the various embodiments.

1. A computer-implemented method comprising:
identifying, using a first computing device, a virtual conference session;
automatically pairing, using the first computing device, with at least another computing device that is executing at least part of the virtual conference session;
receiving, using the first computing device, a gesture-based associated with joining the virtual conference session; and
joining, using the first computing device, the virtual conference session.

2. The computer-implemented method of claim 1, wherein the automatically pairing is accomplished, at least in part, using a Service Set Identifier (SSID) value.

3. The computer-implemented method of claim 1, wherein the automatically pairing further comprises automatically connecting to the another computing device using a wireless connection.

4. The computer-implemented method of claim 1, wherein receiving the gesture-based input comprises receiving a single input in the form of a touch-and-slide input-gesture.

5. The computer-implemented method of claim 1, wherein identifying the virtual conference session further comprises creating the virtual conference session.

6. The computer-implemented method of claim 5 further comprising forwarding an invite to the virtual conference session to at least one potential participant of the virtual conference session.

7. The computer-implemented method of claim 1, wherein joining the virtual conference session further comprises automatically joining the virtual conference session responsive to receiving the single input-gesture.

8. A computer-implemented method comprising:
receiving, using a first computer, a single input-gesture associated with an established virtual conference session;
determining, using the first computer, at least one action associated with the single-input gesture; and
automatically sending, using the first computer, data to a second computer executing at least part of the virtual conference session.

9. The computer-implemented method of claim 8, wherein the data comprises at least one command associated with the virtual conference session.

10. The computer-implemented method of claim 9, wherein the at least one command comprises an action to share content in the virtual conference session.

11. The computer-implemented method of claim 10, wherein the data further comprises at least part of the content to share in the virtual conference session.

12. The computer-implemented method of claim 8, wherein receiving the single input-gesture comprises receiving the single input-gesture via a touch screen.

13. The computer-implemented method of claim 8, wherein the at least one action comprises an action to annotate a display associated with the virtual conference session.

14. The computer-implemented method of claim 8 further comprising receiving, using the first computer, content shared in the virtual conference session from the second computer.

15. One or more computer-readable storage memories embodying processor-executable instructions which, responsive to execution by at least one processor, are configured to:
automatically pair, using a first computing device, the first computing device with a second computing device that is executing at least part of a virtual conference session;
receive, using the first computing device, a first single input-gesture associated with joining the virtual conference session;
responsive to receiving the first single-input gesture, automatically join, using the first computing device, the virtual conference session without additional user input;
receive, using the first computing device, a second single input-gesture associated with said joined virtual conference session;
determine, using the first computing device, at least one action associated with the second single-input gesture; and
automatically send, using the first computing device, data to the second computing device that is executing at least part of the virtual conference session.

16. The one or more computer-readable storage memories of claim 15, wherein the processor-executable instructions to determine the at least one action are further configured to determine the at least one action based, at least in part, on an application that is foremost on an associated display.

17. The one or more computer-readable storage memories of claim 15, wherein the at least one action comprises an action to acquire content shared in said joined virtual conference session.

18. The one or more computer-readable storage memories of claim 15, wherein the processor-executable instructions are further configured to automatically pair with the computing device using a wireless connection.

19. The one or more computer-readable storage memories of claim 15, wherein the second single input-gesture is a touch-and-slide gesture.

20. The one or more computer-readable storage memories of claim 15, wherein the data comprises a command associated with directing an associated behavior of said joined virtual conference session.
